(19) United States
(12) Patent Application Publication
(10) Pub. No.: US 2011/0313940 A1
(43) Pub. Date: Dec. 22, 2011

(54) Process To Optimize A Person's Profile Into A Standardized Competency Profile

(76) Inventors: Jason David Kerr, Auckland (NZ); Stephen Anthony Moir, Auckland (NZ); Paul Anthony O'Donnell, Christchurch (NZ); Curt J. Witte, Chicago, IL (US)

(21) Appl. No.: 12/818,167

(22) Filed: Jun. 18, 2010

(51) Int. Cl. G06Q 10/00

(52) U.S. Cl. 705/321

(57) ABSTRACT

A process to optimize a person's profile information into a standardized competency profile that can then be found for and measured against any specific job position or work need is disclosed herein. The process generates an optimized competency profile for a person comprising a location attribute, an education attribute, a work experience attribute, a plurality of competency matrix attributes and a plurality of job transition attributes. The process obtains the information from various sources including social networking websites, with or without the knowledge of the person. The process is preferably performed at a competency server.

### CROSS REFERENCE TO RELATED APPLICATION

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention generally relates to talent identification. More specifically, the present invention relates to a process to standardize, enhance and optimize disparate personal profile information from different sources into a standardized competency based profile enabling equalized and fast candidate evaluation and selection across multiple sources for recruiting, education, training and career management purposes.

2. Description of the Related Art

The prior art discusses various recruitment technologies. One such reference is Wien et al., U.S. Pat. No. 6,757,674 for a Method And System For Querying And Posting To Multiple Career Websites On The Internet From A Single Interface, which discloses collecting information and mapping the information.

Another reference is Hitchock et al., U.S. Pat. No. 7,376,891 for a Universal Forms Engine, which discloses data sharing between customizable forms.

Yet another reference is Levy et al., U.S. Pat. No. 7,082,418 for a System And Method For Network Based Personalized Education Environment, which discloses comparing an individual's competency profile with an education template and behavior scenario to identify target training or learning areas.

Yet another reference is Brunkow et al., U.S. Pat. No. 5,879,165 for a Method For Comprehensive Integrated Assessment In A Course Of Study Or Occupation which discloses assessing multiple transferable skills.

Job seekers can create personal profiles and post their resumes on a multitude of career websites, corporate websites, or even on personal blogs. Employers searching for candidates to fill a position must go to each website to scan for potential employees. This method of searching for potential employees on each site is considerably time consuming, and all the different tools and processes can be overwhelming.

Since each site collects and stores information according to their own systems, there are variations in data formats, in algorithms, and in specific types of information recorded from the profiles. Retrieving various data from disparate sources for potential candidates results in an inconsistent and incomplete result set which the employer cannot evaluate equally.

As such, there is a need for a system to standardize the profiles from the various sources into a common format and taxonomy; to enhance the profiles in order to eliminate missing values, ensuring consistency; and then to optimize the profile to ensure that it can be appropriately qualified during a search.

With such a system, an employer can perform a search from a single location while the system considers all candidates from any location equally, delivering a result set of the best candidates.

Another problem is that many profile systems vary in the values they allow for their forms allow free format entry of location, specifically country, state, region or ZIP information. This causes issues as you cannot find all potential candidates if they do not conform to the same standard of data for a geo location.

Another problem is a search engine allows employers to search for people within 1, 3, 5, 10, 15, 20, 35, 50 and 100 miles around a fixed point (zip code, etc). To do this requires the search process to work out which profiles to include, based on how far the profiles are away from the job's coordinates (where the employer is searching). This is typically resource intensive and takes time.

Yet another problem is the Internet has made access to global information a reality, but how do you find people based on an education system that differs in each country.

Yet another problem is people and employers/recruiters, all call a job title something different, there is no standardization therefore it is very hard to search for people equally, as one simple spelling mistake may render a person to be excluded in a search.

### BRIEF SUMMARY OF THE INVENTION

The present invention takes profile information in their original data format from different sources and parses that profile data into a set of standardized and optimized searchable data objects, enabling faster searches. The present invention is capable of performing sub-second searches through vast quantities of profile data.

One aspect of the present invention is a process to standardize, enhance and optimize disparate personal profile information from different sources into a standardized competency based profile enabling equalized and fast candidate evaluation and selection across multiple sources for recruiting, education, training and career management purposes.

Another aspect of the present invention is a process to optimize a person's profile information into a standardized competency profile that can then be found for and measured against any specific job position or work need. The process includes identifying a person's information from a plurality of sources comprising at least one business and/or one social networking website, whether self-authored or derived. The process also includes searching the person's profile information for a location string comprising at least one of zip code, metropolitan descriptor, work location, education location or country. The process also includes generating at a competency server a location attribute for a person from the location string of the person's profile information. The location attribute comprises a latitude and longitude and/or North, South, East, West coordinate area for the person. The process also includes searching the person's profile information for an education profile of the person. The education profile comprises at least one term or phrase relating to an education level. The process also includes mapping at the competency server the term or phrase to at least one standard education level of high school level, associates degree level, bachelors degree level, masters degree level, doctorates degree level and post-doctorates degree level to generate an education attribute from the standard education level for the person. The process also includes searching the person's profile information for the person's work experience profile. The process also includes generating at the competency server three experience codes for each of the person's work experiences, based on job title, industry and job overview, to generate a work experience attribute. The process also includes searching the person's work experience profile for a duration string for each work experience, containing at least one of a start date, end date or total elapsed time component for each work experience. The process also includes generating a plurality of competency matrix attributes at the competency server. The process also includes searching a data store for a list of other work experience codes. The process also includes generating a plurality of job transition attributes at the competency server. The process also includes generating at the competency server a optimized competency profile for a person comprising the location attribute, the education attribute, the work experience attribute the plurality of competency matrix attributes and the plurality of job transition attributes.

The present invention receives or retrieves personal profile information from multiple sources via various Application Programming Interfaces (“API”), data transfers, or like technologies. This file is called a Raw Profile. Basic information such as name, email, location, personal overview, and so on. is extracted (where available) from the Raw Profile, without any particular unique intellectual property being specifically used or required/developed.

The present invention also derives whatever location information is provided in the Raw Profile. This could be as broad as a country name, a localized slang term for a region or area of a city, right to a fully detailed country, state, city, or postal data set.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 is a block diagram of the general flow of a system of the present invention.

FIG. 2 is a screen page illustrating a personal website containing information.

FIG. 3 is a flow chart of a specific method of the present invention.

FIG. 4 is a flow chart of a specific method of the present invention.

FIG. 5 is a flow chart of a specific method of the present invention.

FIG. 6 is a flow chart of a specific method of the present invention.

FIG. 6A is a flow chart of a specific method of the present invention.

FIG. 7 is a schematic representation of the location determining function of the present invention.

FIG. 8 is a flow chart of a specific method of the present invention.

FIG. 9 is a flow chart of a specific method of the present invention.

### DETAILED DESCRIPTION OF THE INVENTION

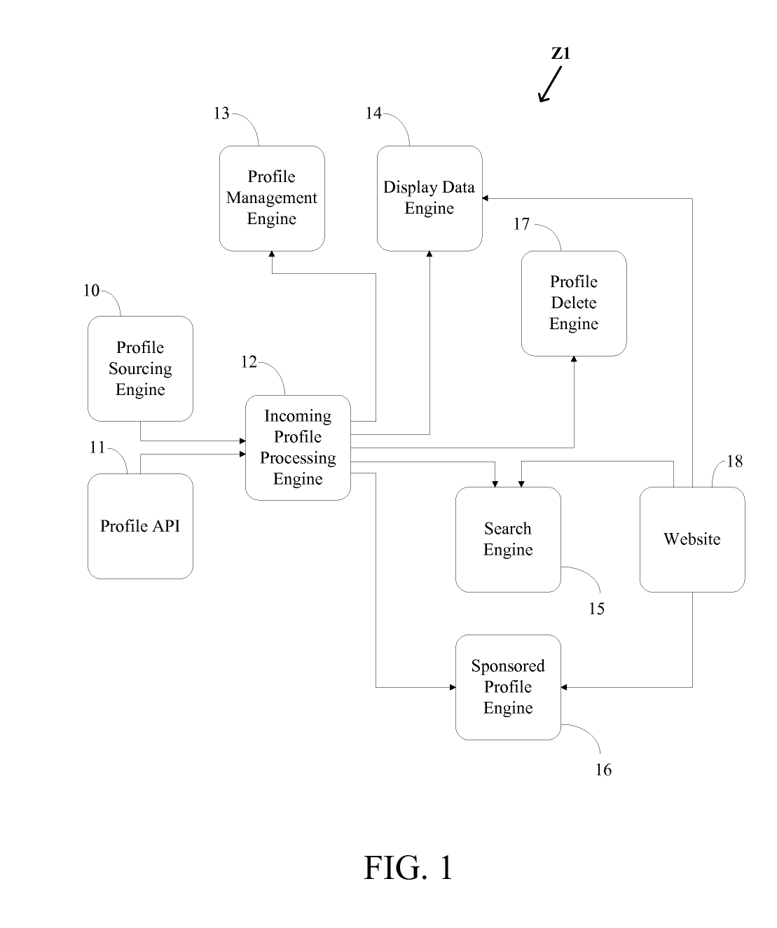

A system Z1, according to a preferred embodiment of the present invention, uses scale-out architecture with non-relational data stores, i.e., NoSQL systems. The preferred embodiment of the present invention comprises of a series of independent engines as shown in FIG. 1. Each engine is developed separately and is independent; so each engine is responsible for queuing and prioritizing its work, and for maintaining and processing its data. This allows various functions to scale at different rates to take advantage of unique technologies that are suited for individual engines, as applicable.

A system Z1 of the present invention simplifies utilizing Platform as a Service (PaaS) hardware. PaaS is a platform layer of cloud computing, offering hardware architecture services over the World Wide Web. A present system Z1 utilizing PaaS speeds up deployment by allowing hardware to be functional online quickly and economically.

In a preferred embodiment, the components of a system Z1 use message queues for communication. The queues allow for multiple application instances to service any request, and allow for prioritizing tasks.

### Overview of the Engines

FIG. 1 shows a system Z1 of the present invention. In a preferred embodiment of the present invention, a system Z1 begins at the Profile Sourcing Engine (PSE) 10. The PSE 10, as one of two sources for incoming profiles, collects resume data, regardless of it's original format, off of websites.

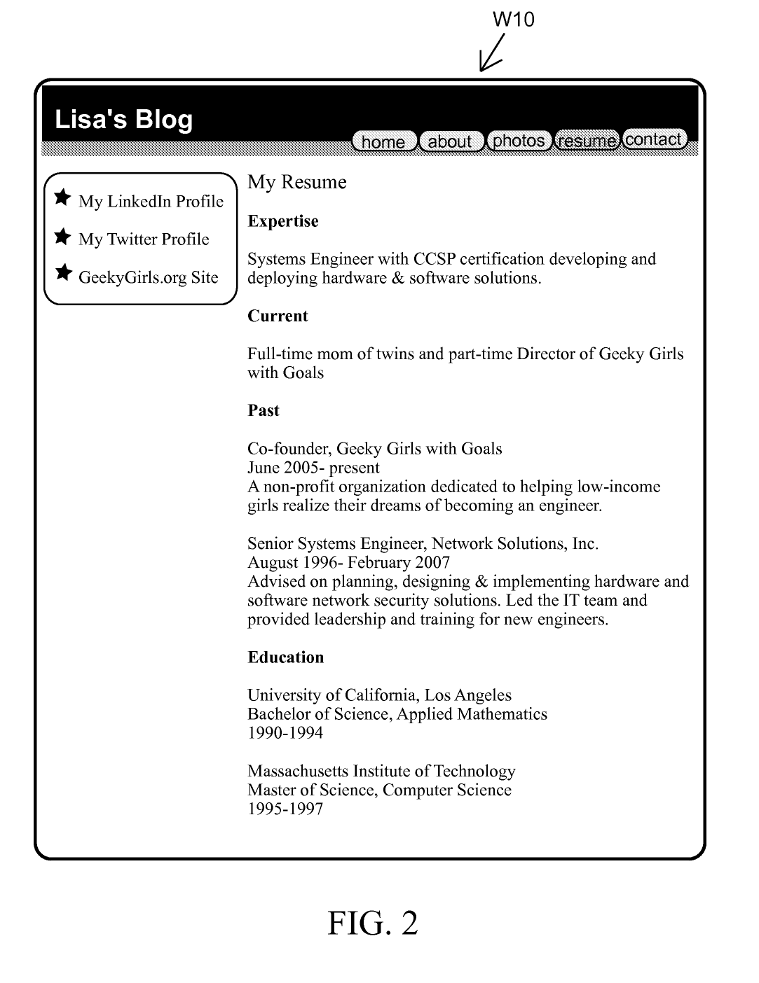

FIG. 2 illustrates a typical personal profile on a web page W10 containing the kind of information that the PSE 10 can take in.

The PSE 10 parses the resumes to standardize the profile, and then converts them into HR-XML format. HR-XML is standardized Extensible Markup Language (XML) vocabularies for human resources (HR) data, the preferred format for a system Z1.

The externally collected resumes can be either new data to a system Z1 or updated data of an existing profile in a system Z1. The PSE 10 also takes in any internal data that needs to be converted into HR-XML. All data exiting the PSE 10 is placed individually onto the update queue of the Incoming Profile Processing Engine (IPPE) 12.

For external scraping of websites such as LinkedIn (a professional networking site on the World Wide Web at linkedin.com), a role is placed on Azure (the Window Azure Queue delivers the messages for the application), which requests files from 80 legs (a service for web crawling and processing web content). The files are read one profile at a time and processed by the PSE 10.

In another embodiment of the present invention, the Profile API (application programming interface) 11, or pAPI, is another source for incoming profiles.

The standardized HR-XML profile data produced by the PSE 10 is called the Raw Profile R10. This Raw Profile R10 data is passed via a message onto the update queue for the IPPE 12.

The message is de-queued and the Raw Profile R10 is categorized based on the data supplied. The categorization includes determining the profile's geographical location and applying specific codes to their work experiences.

After categorization, the Raw Profile R10 is then further optimized with additional inferred data. The IPPE 12 preferably holds data locally but alternatively uses a reference data store to load categorization data out of a start up.

The Raw Profile R10 is then verified to determine if the profile contains sufficient data to be searchable. If the profile does not contain sufficient data to be searchable, the profile is never saved or the profile is deleted from the system Z1, depending on whether or not the profile is present in the database.

The Display Data Engine (DDE) 14 determines if a profile exists in the database. If the profile exists, then it is sent to the IPPE 12 to be processed for deletion by forwarding the Profile to the Profile Delete Engine 17. If the profile does not exist, then the profile is passed onto the Profile Management Engine (PME) 13.

The Profile Delete Engine (PDE) 17 deletes profiles that are no longer needed in a system Z1.

The PME 13 determines if a profile has a profile key, and creates profile keys for profiles that do not have one. The PME 13 returns the Profile to the IPPE 12, which forwards the Profile to the DDE 14 to save the display data of the Profile. That display data is confirmed saved before the Profile is added to the Search Engine (SE) 15.

The PME 13 consists of two parts. One part stores the details, as shown in Table I, for every Profile in a distributed non-relational data store.

TABLE I

| Property | Details |
|---|---|
| SourceType | Details of the system the resume was obtained |
| | from. E.g., Quiet Agent, LinkedIn, AllianceQ, |
| | WMW. |
| SourceID | A unique identifier for a specific source: e.g., a |
| | URL. |
| ProfileID | An integer. |
| ClaimID | This ID is only set if the Profile has been claimed. |
| SponsorType | An enumeration type that determines if the profile |
| | appears in the sponsored listing. |
| Created | |
| Modified | |

The second part of the PME 13 contains Claimed Profile data, which is stored in a distributed partitioned data store. A Claimed Profile is a Profile of which is claimed by a real person as their own; after the person is identified and verified.

The DDE 14 also holds the ProfileID and the display data object for each profile in order to minimize overhead when displaying profile data. When a Website 18 calls for the display data of a profile, the DDE 14 routes the call to the appropriate node, which provides the display data object for the called profile.

In a preferred embodiment: the Website 18 executes calls for all profiles in parallel; the object is composed of arrays of the text sections to populate sections of the screen; and display calls take priority over save calls or delete calls.

The Search Engine (SE) 15 consists of a small number of master nodes that redistribute work out to child nodes. The child nodes all contain a portion of redundant, in memory copies of the total search data. When the child nodes are given search parameters they return a list of the top n-ranked, where n is an integer (e.g., “top 10”, “top 100”), ZIDs in the section of data. ZIDs are a unique internal (Z) identification number (ID) assigned to each profile by a system Z1. The master nodes then sort the results of the top n-ranked profiles and return the result set to the Website 18.

If any nodes fail to return a list within the specified time, the same request is then released to a second instance in the node. Whichever instance returns first supplies the data for the search.

Partitioning for the nodes is done on the basis of IDs, such as 0-1,000,000 on the first server, 1,000,001-2,000,000 on the second server, and so on.

The Sponsored Profile Engine (SPE) 16 provides the Sponsored Profile data for a search. A Sponsored Profile is a profile that an individual or an organization pays to have that profile show up at the top of relevant search results.

The Website 18 has a small partitioned data store for the employer with search and fixed data. However, all of the profile data for the Website 18 is provided by the DDE 14, while the SE 15 and the SPE 16 provides the Website 18 with the ZIDs to display.

### Standardizing the Profile

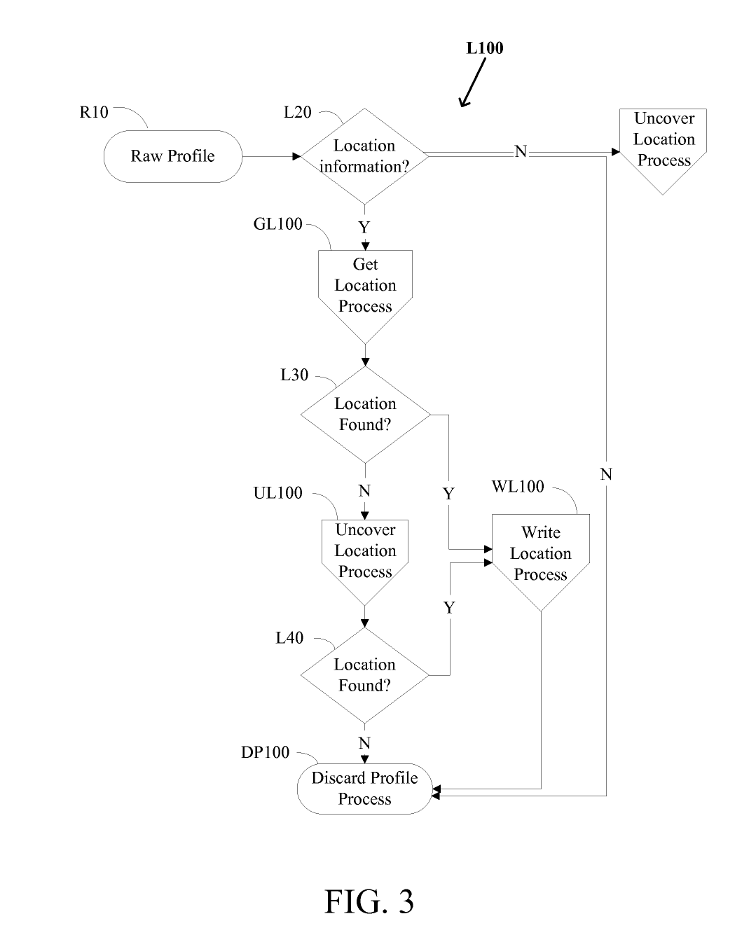

The present invention derives whatever location information is provided from the Raw Profile R10. Location information can be directly found in the Raw Profile data, or location information can be formulated by any, or all, of the location discovery processes, as shown in FIG. 3 through FIG. 6A.

Location information directly found within a profile can be a variety of types; such as, but not limited to, a country name, a localized slang term for a region or area of a city, or a complete postal address set of city, state, country and ZIP code.

If the Raw Profile R10 has any location data then the present invention retrieves that information through a process L100, as shown in FIG. 3.

If the profile R10 does not have location information L20, then the profile moves on to the Uncover Location Process UL100, or to the Discard Profile Process DP100.

If the profile has location information L20, then the data goes to the Get Location Process GL100.

If the location is found L30 after the Get Location Process GL100, then that location is passed to the Write Location Process WL100. The profile is then discarded, Discard Profile Process DP100.

If the location is not found L30 after the Get Location Process GL100, then the profile is passed to the Uncover Location Process UL100.

If the location is found L40 after the Uncover Location Process UL100, then that location is passed to the Write Location Process WL100. The profile is then discarded, Discard Profile Process DP100.

If the location is not found L40 after the Uncover Location Process UL100, then the profile is passed to the Discard Profile Process DP100.

The Write Location Process WL100 is a geocoding process, which will be explained at the end of all the location processes below.

The Discard Profile Process DP100 discards the profile from being processed repeatedly, to end processing.

### Get Location Process

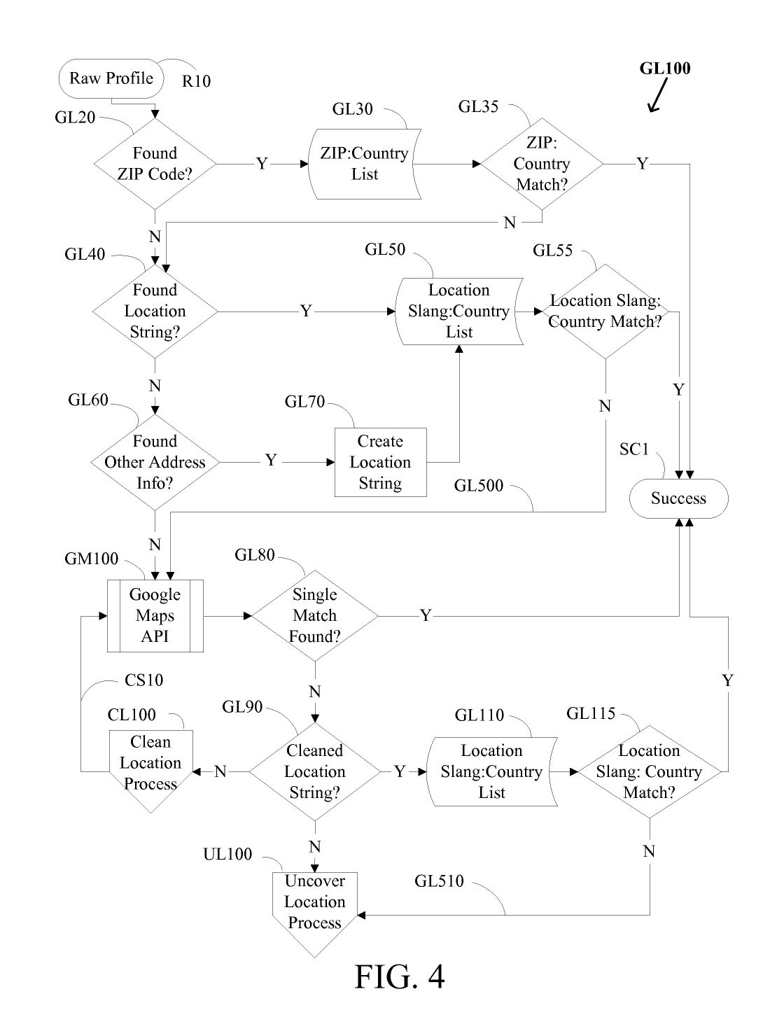

FIG. 4 shows the Get Location Process GL100 of the present invention.

If the Raw Profile R10 has a ZIP code GL20, then the ZIP code is looked up in the ZIP code list to find the corresponding country name GL30. If the ZIP code is matched GL35 to a country name from the tables, then a “SUCCESS” result SC1 is sent back to the calling process (herein referenced as a SUCCESS call SC1).

Otherwise, if there is no ZIP code GL20 in the Raw Profile R10, then the next step is to search for a free format location description (Location String) GL40 in the profile, such as “Greater Boston Area”.

If a String is found GL40 in the profile, then the country name is found by matching the Location String against the Location Slang list in the data tables GL50. If the country is found GL55, return a SUCCESS call SC1. Otherwise, if the country cannot be determined GL55 from the Location String, then the Location String is passed (GL500) to the Google Maps API Process (GMA Process) GM100.

Otherwise, if there is no Location String recognized in the Raw Profile GL40, then the next step GL60 is to search for data elements that contain any other address information from the profile; such as, but not limited to, a city, a region, a state, or a town. If other address information is found GL60, then a Location String will be concatenated GL70 from whatever location information that is available.

The concatenated Location String will be matched against the Location Slang list GL50 to determine the country.

If the country is found from the concatenated Location String GL55, then return a SUCCESS call SC1.

Otherwise, if the concatenated Location String cannot be matched to a country GL55, then the Location String is passed (GL500) to the GMA Process GM100.

The GMA Process GM100 uses the public Google Maps Application Programming Interface (API) to determine a geographical name from the Location String. If a geographical name is determined and it is a single match (for example, “Orange County” is not a single match because there is an Orange County, California and an Orange County, Florida), then the search parameters and the results are both saved to the data tables for future use in searches.

The Location String is passed to the GMA Process GM100.

If Google returns a single match option GL80, then return a SUCCESS call SC1.

Otherwise, if there is no match or if there are multiple matches GL80, and the Location String has not been passed GL90 through the Clean Location Process CL100, then the next step is to pass the Location String to the Clean Location Process CL100. Then, the Cleaned Location String CS10 is passed back through the GMA process GM100 again.

Otherwise, if there is no match or if there are multiple matches GL80 and the Location String has already been passed GL90 through the Clean Location Process CL100, then the Cleaned Location String is matched against the Location Slang list GL110 to determine the country.

If the country is found from a match GL115, then return a SUCCESS call SC1.

Otherwise, if the country could not be found GL115, then the next step (GL510) is to move on to the Uncover Location Process UL100.

### Clean Location Process

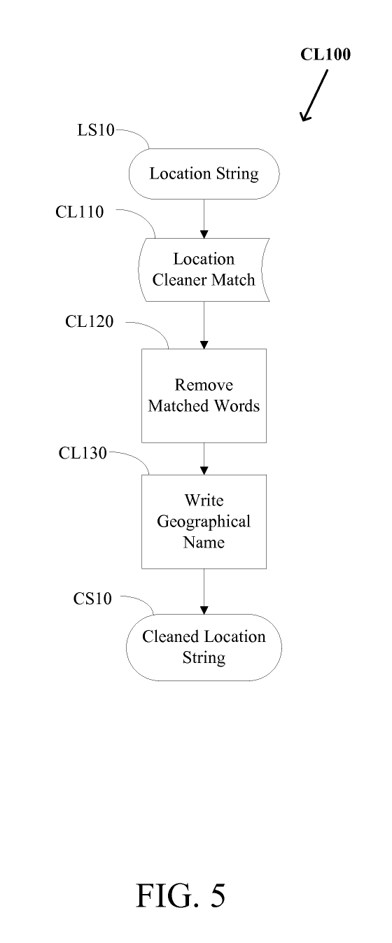

The Clean Location Process CL100, as shown in FIG. 5, takes ambiguous location descriptions, such as “The Greater Boston Area”, and cleans out common words and characters used by people to describe an area.

The Clean Location Process CL100 starts with a string of words or a phrase (Location String LS10). The Location Cleaner table CL110 is used to match up words in the table with words in the Location String LS10 that should be removed from location name. The table has words that people and systems use to define general or specific geographical areas that are typically not standard for the name of a location; such as, but not limited to, “AND”, “&”, “GREATER”, “AREA”, and “LOCAL”. Words can be added to this table at any time.

After removing matching words CL120 from the Location String LS10, the process returns just the geographical name a system (e.g., Google, a search engine), uses to define locations. The process writes CL130 the remaining words to the clean Location String, resulting in a Cleaned Location String CS10.

### Uncover Location Process

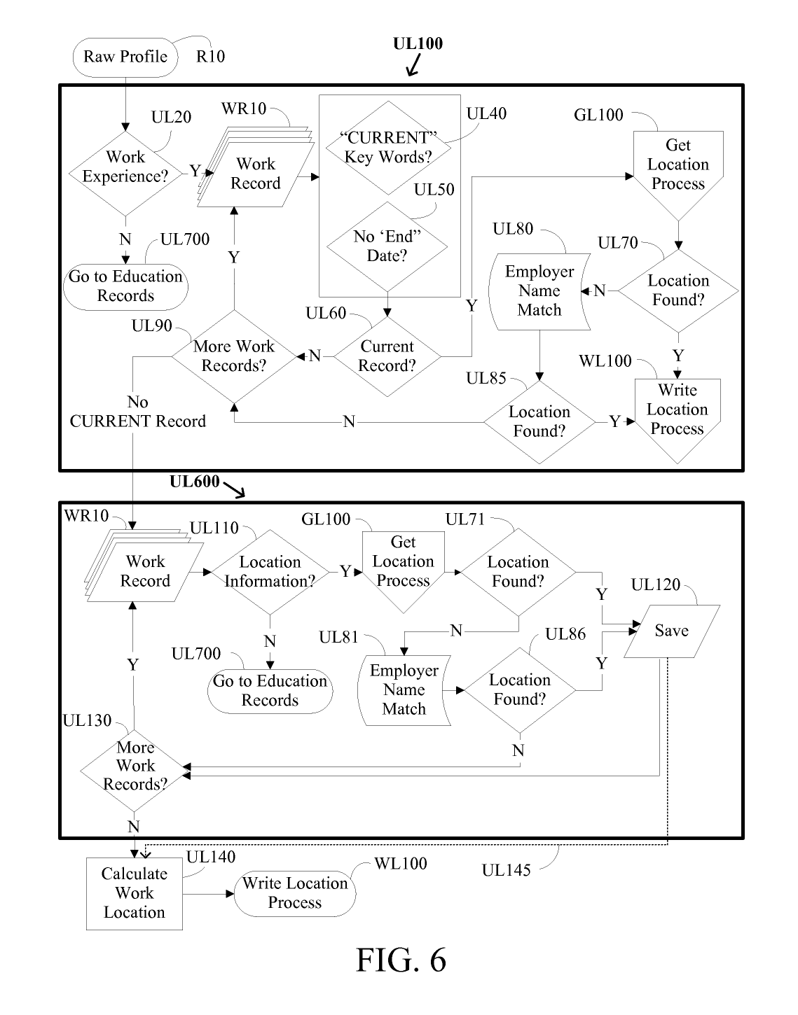

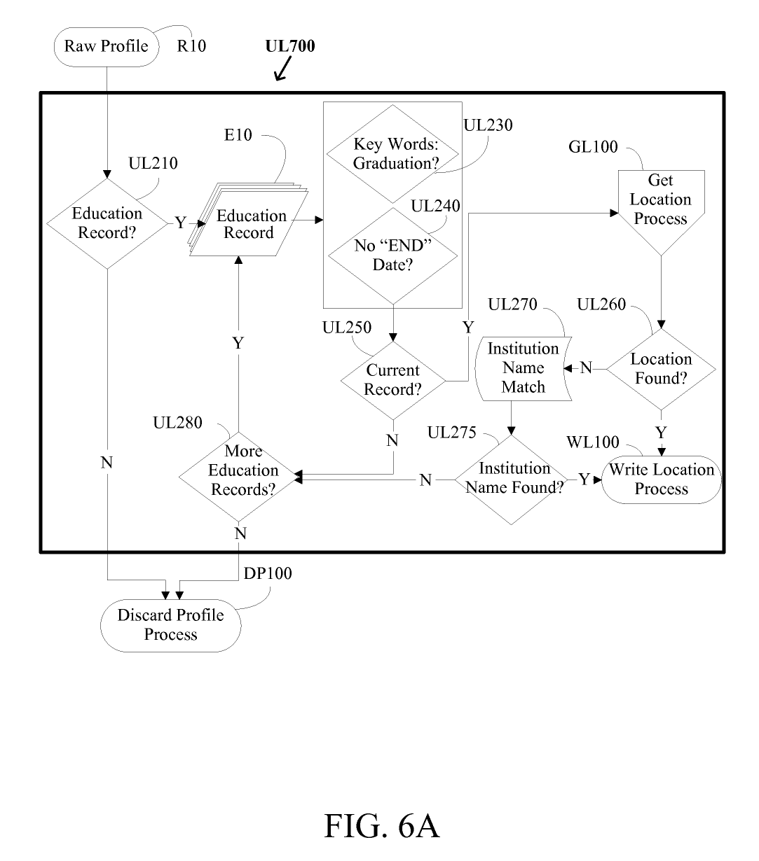

FIG. 6 shows the Uncover Location Process flow UL100.

The Uncover Location Process UL100 derives a probable location attribute of the person based on the sum of the other location information in the Raw Profile R10. The process will assess information such as, but not limited to, the person's current job location, locations in their history of jobs, and their education records.

The Uncover Location Process UL100 starts with any work experience records, Work Record WR10, of the Raw Profile R10.

If the profile has work experience UL20, then each Work Record WR10 is checked to see if there is a “CURRENT JOB” property by using the process (UL40 and UL50) below:

Search the Work Record WR10 for any key words pertaining to a current job UL40, such as “CURRENT”, “CURRENT EMPLOYER”, “STILL EMPLOYED”, and so on; OR,

Search the Work Record WR10 for a null employment “END DATE” property UL50.

If the Work Record WR10 is not a “Current” record UL60, then the process checks for more Work Records WR10 (UL90), until every Work Record WR10 is checked for a “Current” property.

If a work record is derived as “Current” UL60, per the two-step process above, then whatever location information is obtained from that work record is passed on to the Get Location Process GL100.

If the location is found UL70 after the Get Location Process GL100, then that location is passed on to the Write Location Process WL100.

If a Location is not found UL70 after the Get Location Process GL100, then the employer name in the Raw Profile's R10 Work Record WR10 is matched up UL80 against other profiles that contain employer data in their records.

If the employer name matches another employer with location data UL85, then the location information of that employer is passed on to the Write Location Process WL100.

If the employer name is not found UL85 and if there are any more Work Records UL90, the next Work Record WR10 is checked.

If after each Work Record WR10 is checked and none are recognized as “Current” UL90, then the next process UL600 is to search for location information from the Raw Profile's R10 work history.

This next process UL600, as shown in the second half of FIG. 6, calculates the most common location from the collective work locations of the person's work history by determining where the person has spent most of their time. This process will produce at least a state, but can also produce any other location description, such as, but not limited to, city, ZIP code, or Location String.

This process UL600 also compares the Work Record's WR10 employer name with other profile data to determine a location from their employer data.

For each Work Record WR10, any location information the Work Record WR10 contains UL110 is passed to the Get Location Process GL100.

If there is no location information UL110, then the Education Records E10 are checked in another process UL700.

If the location is found UL71, then the information is saved UL120 and the next Work Record WR10 is checked, if any more exist UL130.

If the Get Location Process GL100 did not find a location UL71, then the employer name is checked against other profile information UL81.

If the employer name search UL81 finds a location UL86, then the location information is saved UL120, and the process continues to check UL130 for more Work Records WR10. If the employer name search UL80 does not find a location UL85, then the next Work Record WR10 is checked UL510. After the last Work Record WR10 is processed UL130, the saved location information is used UL145 to calculate a work location UL140.

After the last Work Record WR10 is processed, similar work record locations are grouped into an array by: COUNTRY, STATE, CITY, ZIP, and/or GEO COORDINATES. Then the highest count (being the total number of times a person worked in the same area, representing the most common location a person has worked in across their career), representing the most common location a person has worked in throughout their career, is selected.

If the highest count is less than 2, then the location is set to the most recent work experience, and this location is passed to the Write Location Process WL100.

If there are two more locations with the same count of greater than 1, then the location is set to the highest count with the most recent work experience. This location is passed to the Write Location Process WL100.

If the Raw Profile R10 does not have any Work Records WR10 (at UL20), then the educational records, Education Records E10, are searched for location data through another process UL700, as shown in FIG. 6b.

This process is particularly important for determining the location of those without work records: such as students, the unemployed, others who lack work experience, or from social networking sites such as Facebook (found on the World Wide Web at facebook.com).

If the Raw Profile R10 has Education Records UL210, then each Education Record E10 of the profile is scanned for a “Current” student status by the process below (UL230 and UL240):
Search the Education Record E10 for any “Graduation” data properties, “Graduated” flags, or any key words pertaining to graduation UL230, such as a “GRADUATION”, “FINISH DATE”, “DEGREE RECEIVED”, and so on; OR,
Search the Education Record E10 for a null education “END DATE” property UL240.

If the Education Record E10 is derived as “Current” UL250 from the two-step process above, then any location information obtained from that Education Record E10 is passed to the Get Location Process GL100. Then, any location information found UL260 is passed to the Write Location Process WL100.

If a location is not found UL260 from the Get Location Process GL100, then the institution name from the Education Record E10 is matched UL270 against other profiles that contain the same institution name data in their education records.

If the institution name is found UL275, then the data is passed to the Write Location Process WL100.

Otherwise, if the institution name is not found UL275, the process moves on to the next Education Record E10, if any UL280.

If there is no Education Record E10 in the Raw Profile R10 (at UL210), or after reviewing every Education Record E10 (at UL280), then the Raw Profile R10 is passed to the Discard Profile Process DP100.

The Discard Profile Process DP100 process removes the Raw Profile R10 from the processing queues.

### Write Location Process

The Write Location Process WL100 is the geocoding process. This process simply takes the data collected from the various location discovery processes and sets the geographic coordinates (Geo Coordinates) of the “Current Location” field of a Raw Profile R10. The Geo Coordinates, written as longitude and latitude coordinates, represent a person's residential location.

### Optimizing the Profile for Geo Searching

In the process for optimizing the Raw Profile R10 for geo searching, a series of coordinate values defining the searchable areas this person can be found for is pre-calculated and written to their Optimized Profile. The series of coordinate values is a set of pre-determined distances from the Profile's geo coordinates, such as 5, 10, 25, or 50 miles away from the Profile's location.

The pre-calculated distances in the Optimized Profiles enable faster searching capability, eliminating the time and resource intensive processes of real-time calculations.

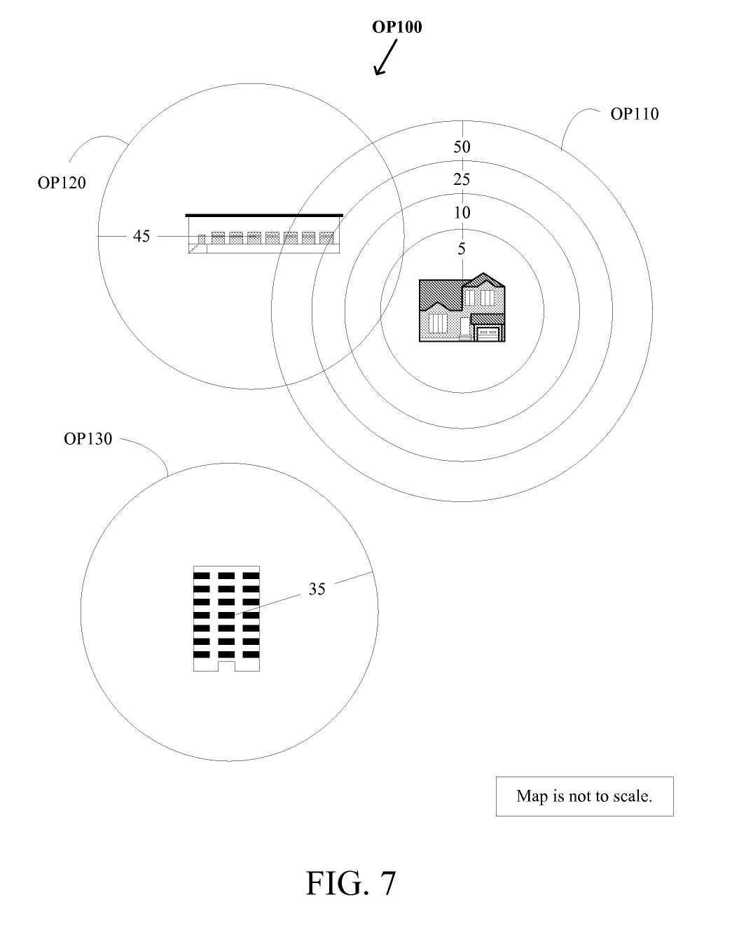

FIG. 7, illustrates an area that a series of coordinates (e.g., 5, 10, 25, and 50 miles away from a profile's house) encompasses OP100. These pre-determined coordinates are in the Optimized Profile. When Employer A searches for candidates within 45 miles of the warehouse OP120, the profile OP110 will show up in the search results of potential candidates for Employer A. When Employer B searches for candidates within 35 miles of the office OP130, the profile OP110 will not show up in the results of potential candidates for Employer B.

### Education Records

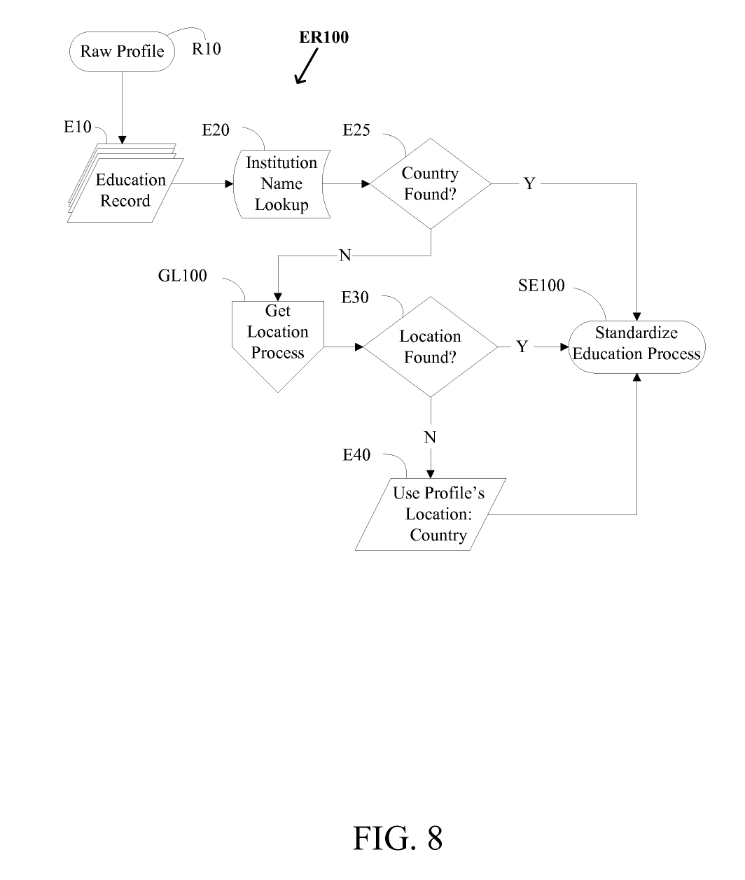

In FIG. 8, a process ER100 extracts a country name, either from the Raw Profile's R10 Education Records E10 or from the Profile's R10 location information, for use in the Standardize Education Process SE100.

For each Education Record E10 the person has in their Raw Profile R10, the name of the institution is checked against institutional names that have a corresponding country in the data tables E20.

If the institution name is matched and a corresponding country is found E25, the name of the country is passed to the Standardize Education Process SE100.

Otherwise, if the institution name is not matched E25 to a country, the Education Record E10 is passed to the Get Location Process GL100.

If a country is found E30 after going through the Get Location Process GL100, then the country is passed to the Standardize Education Process SE100.

Otherwise, if a country is not found E30 after going through the Get Location Process GL100, then the country of the profile's location E40 is passed to the Standardize Education Process SE100.

### Standardize Education Process

The Standardize Education Process SE100 standardizes the various ways people enter, spell, reference, or notate the level of education, in terms of academic degrees, to basic groups (Group).

The data that enters the Standardize Education Process SE100 is the entire Education Record E10.

The Education Record E10 is searched against map-translation terms assigned to each of the educational levels for a country.

Table II shows the map-translation terms; each country has a table of all the country's educational levels.

TABLE II

| Level | Slang | Group |
|---|---|---|
| GED | GED, General Ed Degree, General | High School |
| | Ed, ED, general | |
| Bachelors | Bachelors, BA, BS | Bachelors |
| Masters | Masters, MA, MS | Advanced |
| Doctorate | Double doctorate, PhD | Advanced |

A field in each record contains the slang or common terms used to define each educational level. The profile data entering into a system Z1 comes from profile/candidate systems and databases that allow people to enter free-format or loose information; a person can enter in any type of value rather than pick from a structured list.

The field with the slang terms eliminates the issues a recruiter faces in trying to provide an equal recruitment process, especially with spelling differences or when information is missing.

Each educational level is assigned a Group name, which is recorded into the Raw Profile's R10 Optimized Profile.

Since people are not always sure what level of education they want in their candidate requirements to a specific degree, such as a Master's degree or a Doctoral degree, the educational levels are grouped into basic selection Groups to make the search process simpler for the end user: HIGH SCHOOL, ASSOCIATES, BACHELORS, ADVANCED. Thus, a search result for ADVANCED levels of education will return candidates with Master's degrees or Doctoral degrees, or other advanced degrees.

### Globalizing Education Levels

Educational levels are mapped globally, as shown in Table III, enabling a search to include people with foreign degrees.

Globalizing educational levels allows a United States (U.S.) based user searching Globally, for someone with at least a BACHELORS level of education, to find profiles of people with international degrees equivalent to the U.S. BACHELORS degree.

TABLE III
International Degree Equivalency

| Level | Slang | Group | Regional |
|---|---|---|---|
| GED | GED, General Ed | High | New Zealand: School |
| | Degree, General ed, ed, | School | Certificate |
| | general, and so on. | | New Zealand: Sixth |
| | | | Form Certificate |
| | | | Australia: Certificate 1 |
| | | | Other countries . . . |
| Bachelors | Bachelors, ba, bs, and | Bachelors | United Kingdom - |
| | so on. | | O Level |
| | | | Other countries . . . |
| Masters | Masters, ma, and so on | Advanced | Germany: Diplom |
| | | | Germany: Magister |
| | | | Other countries . . . |
| Doctorate | Double doctorate, PhD, | Advanced | Argentina: doctorado |
| | and so on. | | Other countries . . . |

### Standardize Work Experience Records

The Optimized Profile is based on a standard taxonomy structure and rule set. Essentially, there is a fixed set of options that every element of information is selected from. The elements are stored in the profile data.

A standard taxonomy resolves the exclusion of applicable candidates due to spelling errors, and resolves differing job titles to enable equalized candidate results.

To determine which set of fixed options to exercise on select profiles at select terms, a series of processes, similar to the location processes, determines the element from the taxonomy that best represents the information.

Part of the taxonomy includes using a public standard for job information that provides job attributes; such as skills, tasks, competencies, work activities and a number of other parameters useful in defining the job's ideal person or candidate.

In a preferred embodiment of system Z1, the public standard for job information utilized is the United States Department of Labor/Employment and Training Administration (USDOL/ETA) O*NET (Occupational Information Network) OnLine resource, found on the World Wide Web at online.onetcenter.org.

In another embodiment of system Z1, another data set or a future public standard can be utilized as the standard for job information.

To derive the best potential O*NET Standard Occupational Classification (SOC) Code, a third-party product, O*NET-SOC AutoCoder is used. The O*NET-SOC AutoCoder takes a block of text, such as a job description, and returns a list of probable O*NET SOC occupational codes that are suitable for job classification.

The use of O*NET eliminates the problems of various job titles being interchangeably used for the same job description or function. In a search for “ACCOUNTANT”, a typical search engine that works on key words will find people who are or have been an “ACCOUNTANT”, provided that “ACCOUNTANT” is written somewhere in their job title or description. Using the O*NET-SOC AutoCoder as part of the process below allows searches to uncover not only an “ACCOUNTANT”, but also; “FINANCIAL ANALYST”; “CFO”; “BOOKKEEPER”; and other titles that do not necessarily have “ACCOUNTANT” in their job title or description.

Another outcome of the search can be potential accountants; people who are not accountants but are qualified to become one based on their job history.

### Get AutoCoder Process

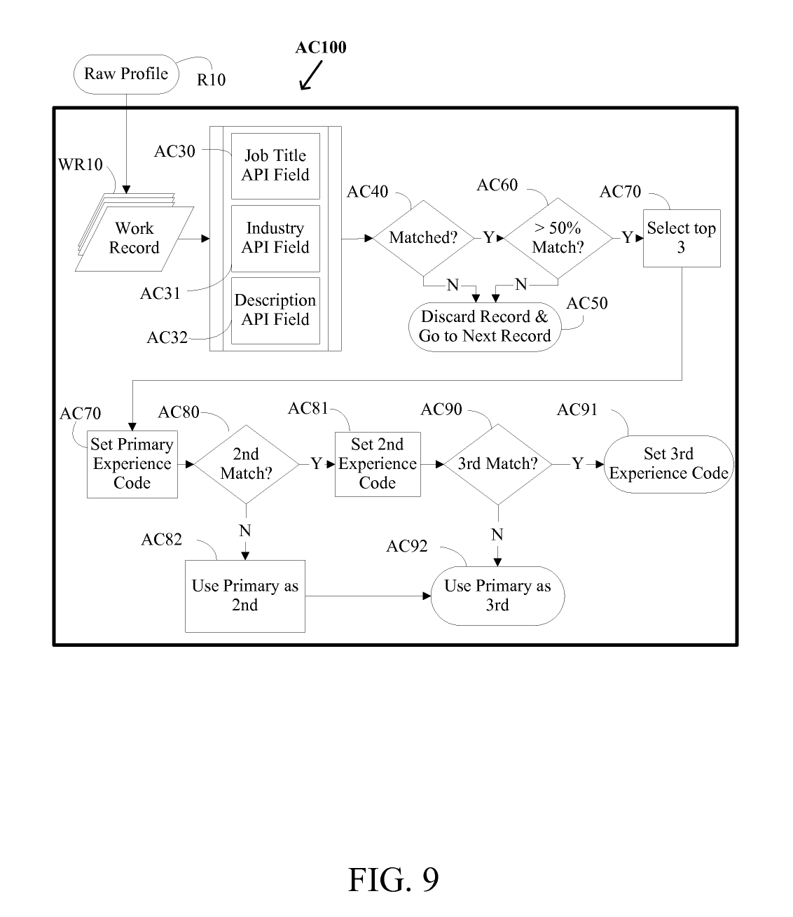

The Get AutoCoder process AC100 is shown in FIG. 9. This process retrieves the O*NET SOC occupational codes for the profile's Work Records WR10, as Experience Codes.

Each Work Record WR10 of the Raw Profile R10 is passed to the Get AutoCoder Process AC100.

The Raw Profile's JOB TITLE is passed into the AutoCoder: JobTitle API field AC30.

The Raw Profile's JOB INDUSTRY is passed to the AutoCoder: Industry API field AC31.

Then the Raw Profile's JOB TITLE, JOB INDUSTRY, and any JOB OVERVIEW contained in the Raw Profile R10 is passed to the AutoCoder: Description API field AC32.

If the AutoCoder returns no matches AC40, then the Work Record WR10 is discarded and the next Record WR10 is passed AC50.

If the AutoCoder returns one or more results AC40, but there are no matches above 50% AC60, then the Record WR10 is discarded and the next Record WR10 is passed AC50. The percentage is of match relevance, this score is provided by O*NET SOC's AutoCoder.

If the AutoCoder returns one or more results AC40 and they have more than a 50% match AC60, then the top three scoring results are selected AC70 for the Primary, Secondary, and Third Experience Codes for the Profile.

From the top three scoring results, the highest scoring result's O*NET Code is saved as the Primary Experience Code AC70 for the Work Record WR10.

If there is a second match AC80, then the second highest scoring result's O*NET Code is saved as the Secondary Experience Code AC81.

Otherwise, if there is no second match AC80, then the Primary Experience Code is saved as the Secondary Experience Code AC82.

If there is a third match AC90, then the third match's O*NET Code is saved as the Third Experience Code AC91.

Otherwise, if there is no third match AC90, then the Primary Experience Code is also saved as the Third Experience Code AC92.

The Get AutoCoder Process AC100, produces three O*NET-SOC Codes, shown in Table IV, which are then assigned to the individual Work Record WR10.

TABLE IV

| Job Title | Primary | Secondary | Third |
|---|---|---|---|
| Accountant | 13-2011.01 | 13-2011.00 | 13-2011.04 |

In the Get Auto-Coder Process AC100 above, a free format job title is rationalized down to three highly probable O*NET-SOC Code matches. This allows the profile to be included in the search process for any job that falls into these three job categories. This typically represents three n×n chances the profile can be found for a relevant job (potential opportunity). “n” is the number of jobs in that category.

Profiles that were slightly misclassified by the Auto-Coder due to some anomaly or to poorly written job titles making it difficult to determine the exact O*NET match can still be found in a search. The Z system basically gives us a ‘fuzzy logic’ approach to help decide WHO gets included in a search based purely on their work history.

### Optimizing the Profile

Optimizing the Profile normalizes skills, tasks, competencies, work activities, knowledge and working styles that a person has or can have accumulated over their entire career, enabling searches to produce a quality result set, as well as enabling a ranked result set.

The WEAM (Work Experience Attribute Matrix) is a predictive competency matrix summarizing all the skills and experiences a person has or can have amassed over their entire career.

In a preferred embodiment, the attributes in the WEAM are based off of the USDOL O*NET standard.

In another embodiment, the attributes in the WEAM can be based off of any occupational standard database.

The WEAM is essentially a score for each attribute required in a job, that relates to the level of application, proficiency, and/or exposure a candidate performing the job should be at, when compared in specific time periods.

Each O*NET job (a job with an assigned O*NET-SOC Code) includes a series of attributes (Attributes) that define the skills, competencies, tasks, and other related requirements specific to the job.

O*NET has defined these core job related Attribute Sets as: SKILLS; TOOLS & TECHNOLOGY; KNOWLEDGE; ABILITIES; WORK ACTIVITIES; WORK CONTEXT; WORK STYLES; and WORK VALUES.

In each Attribute Set there are a number of relevant Attributes: Critical Thinking, Decision Making, and Systems Analysis are just a few of the many Attributes under the SKILLS Attribute Set for an ACCOUNTANT.

O*NET assigns each Attribute a weight, quantifying the importance of that Attribute to the associated job. The value of the weight is utilized as a multiplier to extract an accumulated score amassed during a person's time in a job position for each Attribute pertaining to that job.

The multiplier produces approximately 50,000 different job Attributes, which are ordered, ranked, and weighted for a profile. These job Attributes are mapped and scored during a search to deliver a ranked result set based on the combination of predicative competency across individual Attributes and across Attribute Sets as they apply to various jobs.

The mapping and scoring allows for two individuals with almost an identical work history to be ranked by their experiences or actual performance, as opposed to just by their job titles. If two people working in the same role for the same amount of time move into the same promotion at the same time, but one person also performed a specific function in the previous role that enhances the person's skills for the promotion, then the person without the additional skills will rank lower in competency (shared Attribute scores) than the other person.

Each Attribute for each job in the profile's work history is scored and then formulated to result in a single “Competency Score”, which is the total acquired competency a person has in each Attribute.

The Competency Score given to a profile for any Attribute is determined by a few factors:
a. The length of time performing the job that requires the Attribute;
b. The length of time passed since the person performed the job; and
c. The level of the job, based on requirements, such as experience, training, education, or skills.

Accordingly, the Competency Score will rank a person who is currently performing a job for 3 years higher than a person who performed the same job for 10 years, but 5 years ago.

Attributes Sets are also ranked according to importance. The Attribute Set is valued in relation to the effect its score has on the overall search.

Table V shows the Multipliers, or nominal values, which are used to calculate each individual Attribute. A score for a SKILL based Attribute is about twice as valuable as an Attribute from TOOLS & TECHNOLOGY.

This multiplier is known as the AttributeSet.Multiple.

TABLE V

| | Multiplier |
|---|---|
| | Importance of Attribute Set |
| | in relation to another (set) in |
| Attribute Set | the overall Search |
| Skills | 2 |
| Tools & Technology | 1.2 |
| Abilities | 1 |
| Knowledge | 1 |
| Work Activities | 1 |
| Work Context | 0.8 |
| Work Styles | 0.7 |
| Work Values | 0.6 |

Another multiplier is applied to the score based on the length of time a person performed a role.

This multiplier is known as Time.Scalar, shown in Table VI.

TABLE VI

| Years in a Role | Scalar |
|---|---|
| 0-1 Year | 0.2 |
| 1-2 Years | 0.3 |
| 2-3 Years | 0.4 |
| 3-4 Years | 0.6 |
| 4-5 Years | 0.8 |
| 5-6 Years | 0.9 |
| 6-8 Years | 0.95 |
| More than 8 Years | 1.0 |

Another multiplier is based on the length of time passed since the person performed the job. Lapsed time since experience gained degrades or increases the value of the competency.

This multiplier is known as Recent.Scalar, shown in Table VII.

TABLE VII

| Time Set | Scalar |
|---|---|
| 0-3 Years ago | 1.0 |
| 3-6 Years ago | 0.7 |
| 6-10 Years ago | 0.5 |
| More than 10 years ago | 0.1 |

The WEAM is built using the Weighted Attributes as the starting score for the Attribute, and then the multipliers are used to formulate a Competency Score for the Attribute that relates to the person's time in the job.

Weighted Attributes are Attributes with an assigned O*NET score. The score is based on the Attribute's importance in performing a job.

To begin the process, each Work Record WR10 in a profile sets a time value (TIME).

If the Work Record WR10 has a Start Date and an End Date, then the TIME is set by subtracting the Start Date from the End Date.

Otherwise, if there is no Start Date in the Work Record WR10, then the date at the present time; i.e., Today's Date, is set as the Start Date.

Otherwise, if the End Date is missing, the TIME is set as 18 Months.

The Time.Scalar value corresponding to the TIME value is selected.

Then the Recent.Scalar value corresponding to the length of time passed since performing the job is selected.

For each Weighted Attribute identified in O*NET, related to the job, a Competency Score is calculated by the following formula:

Score=WeightedAttribute.Value×Time.Scalar×Recent.Scalar×AttributeSet.Multiple.

Update WEAM.Attribute.Score=WEAM.Attribute.Score+SCORE. This is related to adding itself to itself as one builds the WEAM.Attribute.Score as one calculates the attribute across multiple work experiences leading to accumulation. For example, Competency Score=Weighted.Attribute.Value×Time Scalar×Recent Scalar×Attribute.Set.Multiple+Competency Score (being the Competency Score one started with before one calculated (ADDED) the score associated to the next work experience.

The result is a compounding or aggregate “Competency Level”, as a score, for each job Attribute a person has experienced over their career. If a person has been exposed to the same Attribute multiple times from various jobs, then the WEAM.Attribute.Score ensures that the person's Competency Level adjusts appropriately in the aggregate.

The WEAM is re-calculated monthly to update the scores based on real time to ensure that people with “Current” experiences continue to score higher than people with past experiences.

### Skills & Job Fit

Eight O*NET Attribute Sets define key areas of work experience:

d. SKILLS;

e. TOOLS & TECHNOLOGY;

f. KNOWLEDGE;

g. ABILITIES;

h. WORK ACTIVITIES;

i. WORK CONTEXT;

j. WORK STYLES; and

k. WORK VALUES.

The individual Attributes that have been scored in the process above can be grouped into these Attribute Sets to give combined scores for a set.

The Attribute Sets are bundled into two groups, SKILLS and JOB FIT, as shown in Table VIII.

TABLE VIII

| GROUP | CONTAINS O*NET ATTRIBUTE SETS |
|---|---|
| SKILLS | Skills |
| | Tools and Technology |
| JOB FIT | Knowledge |
| | Abilities |
| | Work Activities |
| | Work Context |
| | Work Styles |
| | Work Values |

With the two groups, two scores are pre-calculated for every job a person has performed, or for every potential job the person can perform.

The SKILLS and JOB FIT SKILLS and JOB FIT scores for every job in the profile is saved to the Optimized Profile.

Further use of the SKILLS and JOB FIT scores is in the Search and Rank algorithm.

From the it is believed that those skilled in the pertinent art will recognize the meritorious advancement of this invention and will readily understand that while the present invention has been described in association with a preferred embodiment thereof, and other embodiments illustrated in the accompanying drawings, numerous changes, modification and substitutions of equivalents may be made therein without departing from the spirit and scope of this invention which is intended to be unlimited by the foregoing except as may appear in the following appended claim. Therefore, the embodiments of the invention in which an exclusive property or privilege is claimed are defined in the following appended claims.

1. A process to optimize profile information corresponding to a person into an optimized competency profile, the process comprising:
scraping the profile information for the person from a plurality of sources comprising at least one of a business website and a social networking website, the profile information comprising location information associated with the person, an education profile associated with the person, and one or more work experiences associated with the person;
identifying, from the scraped profile information, the location information associated with the person, the location information comprising at least one of a zip code, a metropolitan descriptor, a work location, an education location or a country;
generating, at a competency server, a location attribute for the person based on the identified location information, the location attribute comprising at least one of latitude and longitude coordinates and a North, South, East, West coordinate area associated with the person;
identifying, from the scraped profile information, the education profile associated with the person, the education profile comprising at least one term or phrase relating to an education level obtained by the person;
mapping, at the competency server, the term or phrase relating to the education level to at least one standard global education level from a set of global education levels, the set of global education levels comprising high school level, associates degree level, bachelors degree level, masters degree level, doctorates degree level and post-doctorates degree level;
generating an education attribute for the person comprising the mapped at least one standard global education level;
identifying, from the scraped profile information, the one or more work experiences associated with the person;
for at least one identified work experience for the person, generating at the competency server, three experience codes, the three experience codes generated based on a job title, an industry and job overview associated with the at least one identified work experience and each experience code describing a distinct occupation associated with the at least one identified work experience;
for each of the three experience codes, generating a plurality of competency matrix attributes for the person at the competency server, the plurality of competency matrix attributes for each experience code comprising one or more skills that are associated with the experience code, the one or more skills assumed to be possessed by the person; and
generating, at the competency server, an optimized competency profile for the person comprising the location attribute, the education attribute, the three experience codes, and the plurality of competency matrix attributes associated with each of the three experience codes.

2. A computer program product comprising executable instructions for optimizing profile information corresponding to a person into an optimized competency profile, the instructions when executed by a computer processor cause the processor to:
scrape the profile information for the person from a plurality of sources comprising at least one of a business website and a social networking website, the profile information comprising location information associated with the person, an education profile associated with the person, and one or more work experiences associated with the person;
identify, from the scraped profile information, the location information associated with the person, the location information comprising at least one of a zip code, a metropolitan descriptor, a work location, an education location or a country;
generate a location attribute for the person based on the identified location information, the location attribute comprising at least one of latitude and longitude coordinates and a North, South, East, West coordinate area associated with the person;
identify, from the scraped profile information, the education profile associated with the person, the education profile comprising at least one term or phrase relating to an education level obtained by the person;
map the term or phrase relating to the education level to at least one standard global education level from a set of global education levels, the set of global education levels comprising high school level, associates degree level, bachelors degree level, masters degree level, doctorates degree level and post-doctorates degree level;
generate an education attribute for the person comprising the mapped at least one standard global education level;
identify, from the scraped profile information, the one or more work experiences associated with the person;
for at least one identified work experience for the person, generate three experience codes, the three experience codes generated based on a job title, an industry and job overview associated with the at least one identified work experience and each experience code describing a distinct occupation associated with the at least one identified work experience;
for each of the three experience codes, generate a plurality of competency matrix attributes for the person at the competency server, the plurality of competency matrix attributes for each experience code comprising one or more skills that are associated with the experience code, the one or more skills assumed to be possessed by the person; and
generate an optimized competency profile for the person comprising the location attribute, the education attribute, the three experience codes, and the plurality of competency matrix attributes associated with each of the three experience codes.
